(19) United States
(12) Patent Application Publication
(10) Pub. No.: US 2013/0239729 A1
(43) Pub. Date: Sep. 19, 2013

(54) Internal gear shift for a manual transmission and manual transmission for a motor vehicle

(71) Applicant: GM GLOBAL TECHNOLOGY OPERATIONS LLC, Detroit, MI (US)

(72) Inventors: Olaf HELDMANN, Buettelborn (DE); Christian KUNZE, Gross-Gerau (DE)

(73) Assignee: GM GLOBAL TECHNOLOGY OPERATIONS LLC, Detroit, MI (US)

(21) Appl. No.: 13/782,705

(22) Filed: Mar. 1, 2013

(30) Foreign Application Priority Data
Mar. 14, 2012 (DE) 10 2012 005 102.6
Feb. 15, 2013 (DE) 102013002684.9

(51) Int. Cl. F16H 61/26

(52) U.S. Cl. CPC F16H 61/26
USPC 74/473.1

(57) ABSTRACT

An internal gear shift for a manual transmission is provided. The internal gear shaft includes a shifting shaft mounted rotationally moveably about its axis and displaceably in axial direction, counter-engagement means, and at least two engagement elements. The engagement elements interact with the counter-engagement means in order to lock the shifting shaft in at least one rotary position and in at least one stroke position. One of the engagement elements locks the shifting shaft in the stroke position and the other engagement element locks the shifting shaft in the rotary position. The engagement elements are movable against the counter-engagement means through the force of a common spring element.

### CROSS-REFERENCE TO RELATED APPLICATION

This application claims priority to German Patent Application No. 10 2012 005 102.6, filed Mar. 14, 2012, and to German Patent Application No. 10 2013 002 684.9, filed Feb. 15, 2013 which are incorporated herein by reference in their entirety.

### TECHNICAL FIELD

The technical field relates to an internal gear shift for a manual transmission having a shifting shaft, which is rotation-movably mounted about its axis and displaceable in an axial direction, and having at least two engagement elements, which interact with counter-engagement means in order to lock the shifting shaft in at least one rotary position and in at least one stroke position, wherein one of the engagement elements serves for locking the shifting shaft in the stroke position and the other one of the engagement elements for locking the shifting shaft in the rotary position. The technical field furthermore relates to a manual transmission for a motor vehicle.

### BACKGROUND

A gear shift serves for shifting a manual transmission, for example of a motor vehicle, from one gear into another gear. To this end, the gear shift comprises a shifting shaft, which is mounted rotation-movably about its central axis and displaceably in axial direction. Through the displacement movement, the shifting shaft is usually displaced along a so-called gate in order to enter into an active connection with different shifting elements depending on position, for example in the manner of a shifting fork. Through the rotary movement, the shifting element on the manual transmission is actuated in order to engage a gear. In this way, shifting into a plurality of different gears of the manual transmission is possible through the gear shift. Usually, the internal gear shift is directly arranged on the housing of the manual transmission, for example accommodated at least partially in a separate housing, the so-called gear shift cover.

In order to fix the shifting shaft in the assumed position with the gear engaged, the gear shifts usually comprise two engagement elements, which interact with counter-engagement means. Here, one of the engagement means usually serves for locking the shifting shaft in a stroke position and the other one of the engagement elements for locking the shifting shaft in a rotary position.

Usually, the engagement elements are prefabricated units, which for example are mounted to the gear shift cover and comprise an engagement body as well as a guide body. The engagement body enters into active contact against the respective associated counter-engagement means and the guide body makes possible at least to a limited extent a guide movement along a counter-guiding surface in order to be able to bring the connected engagement body into the locking position against the respective counter-engagement means and also out of it again. This mechanism for moving the respective engagement element into the locking position has been relatively bulky and requires a relatively large installation space in order to be able to mount the gear shift cover including the internal gear shift to the housing of the manual transmission. Altogether, the assembly of the gear shift is rendered more difficult because of this.

A further aspect is that with the new development of vehicles a bulky gear shift and thus a bulky gear shift cover is to be preferably avoided in order to adhere to the high demands in terms of pedestrian protection. The aim, in this respect, is to preferably accommodate the shifting mass of the internal gear shift in a region under the battery support of a motor vehicle, so that the shifting mass can freely oscillate even in this region.

It is therefore desirable to provide an internal gear shift having the features mentioned at the outset, which can be installed in a compact manner in the region of its engagement elements and counter-engagement means. It is also desirable to provide a manual transmission for a motor vehicle, which manual transmission is suitable for interacting with such an internal gear shift. In addition, other objects, desirable features and characteristics will become apparent from the subsequent summary and detailed description, and the appended claims, taken in conjunction with the accompanying drawings and this background.

### SUMMARY

In accordance with an exemplary embodiment, an internal gear shift for a manual transmission has an internal shifting shaft which is mounted rotation-movably about its axis, in particular its center axis, and displaceably in axial direction. The gear shift furthermore comprises two engagement elements, which interact with counter-engagement means in order to lock the shifting shaft in at least one rotary position and in at least one stroke position, wherein one of the engagement elements serves for locking the shifting shaft in the stroke position and the other one of the engagement elements for locking the shifting shaft in the rotary position.

According to an embodiment, the engagement elements are moved against the counter-engagement means through the force of a common spring element. Through this measure, the gear shift can be realized in a compact manner in the region of its locking device since the engagement elements make use of a common component, namely the spring element. Compared with a gear shift in which each engagement element interacts with a respective associated spring element, one spring element is saved resulting in less space requirement for the engagement elements and the gear shift altogether becomes lighter in terms of weight.

The gear shift in an embodiment is arranged at least partially within a housing, in particular a gear shift cover, wherein the housing or the gear shift cover can be mounted or is mounted on the housing of a manual transmission. The gear shift cover or housing can be a housing that is located on the outside. Through the gear shift the housing or the gear shift cover can be constructed in a particularly compact manner so that the at least one shifting mass of the gear shift is to be accommodated with adequate spacing below the battery support of the motor vehicle in order to be able to oscillate without interference.

According to an exemplary embodiment, the engagement elements are moved against the counter-engagement means in radial direction with respect to the shifting shaft and the spring element is arranged between the engagement elements. This measure also aims at a structurally compact construction of the gear shift, in particular in the region of its engagement elements. Insofar as the engagement elements each comprise an engagement body which enters into an active position with the associated counter-engagement means, the spring element is advantageously located at least between the engagement bodies of the engagement elements.

I In another embodiment, the engagement elements can be moved in radial direction with respect to the shifting shaft towards the outside through the force of the spring element. For example, the engagement element can be arranged diametrically with respect to one another in radial direction with respect to the shifting shaft, so that they can be moved towards the outside with respect to one another in opposite direction. These measures also aim at constructing the gear shift in a compact manner. For by rendering the engagement elements movably towards the outside, the gear shift is designed in a compact manner in particular in radial direction.

This is the case in a further embodiment when, in radial direction with respect to the shifting elements, the engagement elements are arranged located inside and the counter-engagement means located outside. Because of this, engagement elements projecting towards the outside are avoided since the outer limit is formed through the counter-engagement means.

According to an exemplary embodiment, the engagement elements are arranged in a common plane substantially located perpendicularly to the axis of the shifting shaft. Because of this, a particularly compact construction of the gear shift is realized in axial direction of the shifting shaft in the region of the engagement elements, for the engagement elements are located in axial direction of the shifting shaft substantially without or largely without offset with respect to one another.

In another embodiment, the engagement elements in radial direction with respect to the shifting shaft are movably mounted in such a manner that the engagement elements move in a common plane substantially located perpendicularly with respect to the axis of the shifting shaft. Because of this, the gear shift in the region of the engagement elements in axial direction of the shifting shaft is reduced to a minimal space requirement.

According to a further embodiment, one of the engagement elements is translatorically movably mounted on the other engagement element, wherein the other engagement element in turn is translatorically movably held on the shifting shaft, in particular in a mounting or a housing of the shifting shaft. Because of this, a compact mounting is achieved so that at least in radial direction a small construction arrangement of the engagement elements is obtained in a technically simple manner since merely one of the engagement elements is mounted on the shifting shaft. In order to also hold the other engagement element translatorically movably, the engagement element already mounted on the shifting shaft is utilized with this configuration.

In this embodiment, the one engagement element is translatorically movably mounted on the other engagement element subject to the intermediate connection of a bearing, in particular sliding bearing or rolling bearing, such as for example a recirculating ball bushing.

Additionally or alternatively, the other engagement element may be translatorically movably mounted on the shifting shaft subject to the intermediate connection of a bearing, in particular sliding bearing or rolling bearing, such as for example a recirculating ball bushing.

Through the sliding bearing and/or the rolling bearing of at least one of the engagement elements, an easy-to-operate movability of the engagement elements is ensured so that the engagement elements can also carry out smallest translatoric movements in radial direction with respect to the shifting shaft.

In an embodiment, one engagement element which is translatorically movably mounted on the other engagement element serves for locking the shifting shaft in the at least one rotary position. Because of this, a locking of the shifting shaft in the rotary position is ensured even against such counter-engagement means which for example comprise a plurality of mountings arranged at a small distance from one another for mounting the engagement element. In order to ensure locking with these smallest distances, an engagement element which easily responds in its outward movement is required. This requirement is taken into account in that the engagement element, which is movably mounted on the other engagement element, serves for locking the shifting shaft in the rotary position. Through the force of the spring element, this engagement element in its movement responds faster than the engagement element mounted on the shifting shaft.

In an embodiment, the engagement element which is translatorically movably mounted on the shifting shaft is utilized for locking the shifting shaft in the at least one rotary position.

In another embodiment, the engagement elements each comprise or are formed of an engagement body and a support body carrying the engagement body. The engagement body is formed in order to enter into an active position against the counter-engagement means. For example, the engagement body can be formed through a ball, roller or similar element, which is suitable in order to create a locking connection with the counter-engagement means.

In a further embodiment, the engagement body of at least one of the engagement elements is rotatably mounted on the associated support body about at least one rotary axis. The engagement body is thus designed in order to be able to carry out a rotary movement relative to the support body. Because of this, the gear shift can be operated particularly easily since for transferring the shifting shaft from a rotary position into another rotary position and/or from a stroke position into another stroke position the associated engagement body can roll on the associated counter-engagement means so that the engagement body can be smoothly brought into the locking position against the counter-engagement means with little force expenditure.

In addition to its function of support for the engagement body, the support body can additionally serve as guide body so that through the support body a guided movement of the engagement element in the direction against the associated counter-engagement means is achieved.

For example, one of the support bodies can be movably or displaceably mounted on the other support body in radial direction with respect to the shifting shaft, wherein the other support body in turn is movably or displaceably mounted on the shifting shaft in radial direction.

At least one bearing can also be provided for the mounting of at least one of the support bodies. For example, one of the support bodies can be movably mounted on the other support body subject to the intermediate connection of a bearing in radial direction with respect to the shifting shaft, wherein the other support body in turn is movably mounted in radial direction on the shifting shaft subject to the intermediate connection of a further bearing.

In an embodiment, the support bodies mounted on the shifting shaft and the bearing connected in between are a plastic part or plastic hybrid part. In that the support body and the bearing are each a plastic part or plastic hybrid part, a decoupling of vibrations is particularly effectively achieved.

The bearing, in particular sliding bearing or bearing bushing, can be formed on the associated support body, in particular molded on. In an embodiment, the support body and the bearing, in particular sliding bearing or bearing bushing, form a common plastic part or plastic hybrid part. By mounting the support body the bearing is mounted at the same time. A separate mounting of the bearing is not required.

The shifting shaft or a housing of the shifting shaft which is in active contact with the bearing which then consists of plastic at least in the contact region with the bearing may ensure a wear-free axial moving of the support body relative to the shifting shaft.

In an embodiment, the bearing, in particular sliding bearing or bearing bushing, is molded onto the shifting shaft or the housing of the shifting shaft which the bearing abuts. The shifting shaft and the housing can also be of metal. The mounting of the bearing is also saved through this measure, since it is already present on the shifting shaft.

According to an embodiment, the bearing, for example sliding bearing or bearing bushing, is formed through at least one wall which on the circumference-side comprises a plastic layer located inside, which is surrounded by a metal structure, such as for example a metal sleeve. The plastic layer, for example is surrounded by a metal structure and an elastomer structure, wherein the elastomer structure is located between the plastic layer and the metal structure. Because of this, a high degree of vibration decoupling with high stability of the mounting at the same time is achieved. The metal structure or the metal sleeve furthermore makes possible an optimal mounting of the bearing for example on the shifting shaft.

Another embodiment aims in the same direction, according to which the at least one ball of the bearing, for example sliding bearing or bearing bushing, is formed through a metal structure or a metal sleeve, which is molded over with plastic, so that in this way a plastic structure is formed.

Sound sliding characteristics combined with a high degree of decoupling of vibrations are achieved when according to a further embodiment the support body mounted on the bearing, for example sliding bearing or bearing bushing at least with its contact surface consists of plastic, in particular, the support body is a plastic component or plastic hybrid component, and the plastic layer of the bearing, sliding bearing or of the bearing bushing, forms the contact surface to the support body. The bearing for example is fastened against the shifting shaft, in particular installed by way of a press fit. For example, the metal structure of the bearing, for example sliding bearing or bearing bushing, to this end is produced to a predetermined dimension so that because of this the press fit relative to the shifting shaft can be achieved.

In an embodiment, the support bodies are designed cylindrically and at least one of the support bodies is a hollow cylinder located in radial direction with respect to the shifting shaft, in which the other support body, if required subject to the intermediate connection of a sliding bearing or rolling bearing, for example of a bearing of the type described above, is mounted. In that the one support body is received in the hollow space of the other support body, i.e., the one support body is pushed or can be pushed into the other support body, a compact arrangement in radial direction with respect to the shifting shaft of the two support bodies with respect to one another is realized. Here, the support body located outside serves as mounting for the pushed-in support body located inside.

In another embodiment, the spring element is arranged in the hollow space of the support body designed as hollow cylinder. Because of this, the hollow space which is already present anyway is utilized for mounting the spring element, through the force of which the engagement elements are brought into locking position against the counter-engagement means.

A particularly compact configuration of the gear shift in the region of the engagement elements is achieved when according to a further embodiment both support bodies are formed as a hollow cylinder and the one support body is mounted in the other support body if appropriate subject to the intermediate connection of a sliding bearing or rolling bearing, in particular of a bearing of the type described above, wherein the spring element is mounted in the support body located inside.

The common spring element on the one hand can support itself against the one support body and on the other hand against the other support body. For example, the spring element can support itself against material portions each extending on the face end on the hollow cylinder at least partially.

The spring element can be a compression spring, which is formed for example in the manner of a coil spring. Preferably, the spring element is a metal spring element.

In an embodiment, at least one of the support bodies is movably mounted against a housing that is connected to the shifting shaft for example in a movement-fixed manner or against a mounting connected to the shifting shaft, for example a mounting of the type described above, if appropriate subject to the intermediate connection of a sliding bearing or rolling bearing, for example of a bearing of the type described above, in radial direction with respect to the shifting shaft. Because of this, the at least one support body is movably mounted on the shifting shaft in a low-friction manner so that on actuating the shifting shaft the movability of the support body mounted on the housing or the mounting is ensured in order to lock the shifting shaft in the at least one stroke position or rotary position.

A particularly compact-construction mounting of the support body is achieved when according to an embodiment at least one support body is formed as a hollow cylinder and the other support body is mounted therein, wherein the support body formed as a hollow cylinder in turn is movably mounted on the housing or mounting connected to the shifting shaft.

According to a further embodiment, the shifting shaft is divided into at least two longitudinal portions and the engagement elements are arranged in between. Because of this, the shifting shaft despite the engagement elements formed thereon has two free ends, through which in a technically simple manner an integration of the shifting shaft in the entire shifting mechanism of the internal gear shift is achieved.

In another embodiment, the counter-engagement means are formed as contour on the inner circumference of a hollow cylinder, for example in the manner of a sleeve, bushing or the like. Because of this, the counter-engagement means are realized in a compact construction and in a technically simple manner since both the counter-engagement means for the one engagement element as well as the counter-engagement means for the other engagement element can be formed or are formed on a common hollow cylinder and for this purpose the inner circumference of the hollow cylinder is utilized.

According to a further embodiment a manual transmission for a motor vehicle having an internal gear shift of the type described above is provided.

### BRIEF DESCRIPTION OF THE DRAWINGS

The various embodiments will hereinafter be described in conjunction with the following drawing figures, wherein like numerals denote like elements, and wherein:

FIG. 1 is a perspective view of a gear shift cover for mounting a gear shift, wherein the gear shift cover is mounted on a housing of a manual transmission for a motor vehicle and spaced from the housing a battery carrier for the motor vehicle is located, according to an exemplary embodiment;

FIG. 2 is a lateral view of a part of an internal gear shift, which can be integrated in the gear shift cover of FIG. 1, with engagement elements, wherein the associated counter-engagement means have been omitted, according to an exemplary embodiment;

FIG. 3 is a perspective view of the gear shift according to FIG. 2, wherein the engagement elements and the associated counter-engagement means are shown, in accordance with an exemplary embodiment;

FIG. 4 is a sectional view of the engagement elements of the gear shift according to FIG. 3 in accordance with an exemplary embodiment;

FIG. 5 is a cross-sectional view of a mounting of the engagement elements in the gear shift according to the FIGS. 2 and 3, in accordance with an exemplary embodiment;

FIG. 6 is a cross-sectional view in an enlarged perspective detail of a bearing for mounting the engagement elements from a gear shift in accordance with an exemplary embodiment;

FIG. 7 is a cross-sectional view for the mounting of the engagement elements, as it is employed in the gear shift according to the FIGS. 2 and 3 in accordance with another exemplary embodiment; and

FIG. 8 is a perspective view of the mounting according to FIG. 7.

### DETAILED DESCRIPTION

The following detailed description is merely exemplary in nature and is not intended to limit the various embodiments or the application and uses of thereof. Furthermore, there is no intention to be bound by any theory presented in the preceding background or the following detailed description.

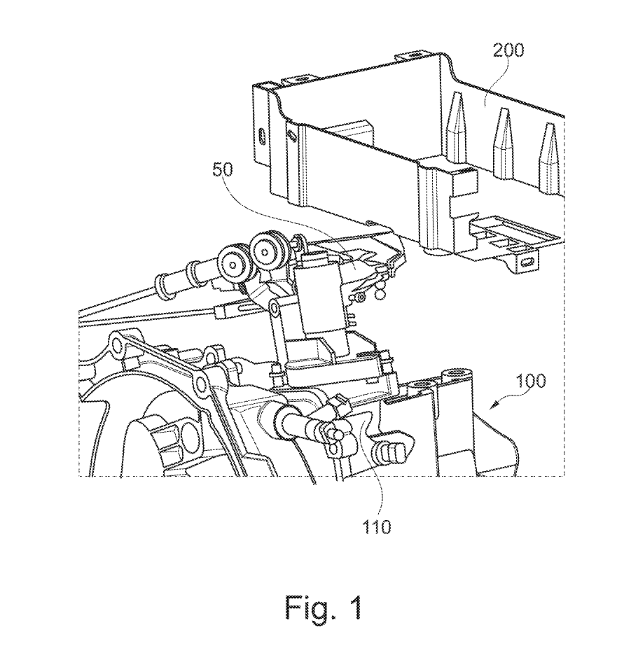

FIG. 1 shows—in a part representation, a manual transmission 100 and a battery support 200, as they are both installed for example in a motor vehicle. Here, the battery support 200 is located spaced from the transmission housing 110 of the manual transmission 100.

In an exemplary embodiment, on the transmission housing 110, a housing 50 standing away towards the outside is mounted, which for example can be formed in the manner of a gear shift cover. The housing 50 is formed in such a compact manner that with its upper end it terminates below the lower end of the battery support 200, i.e. substantially remains completely in the intermediate space between the battery support 200 and the transmission housing 110.

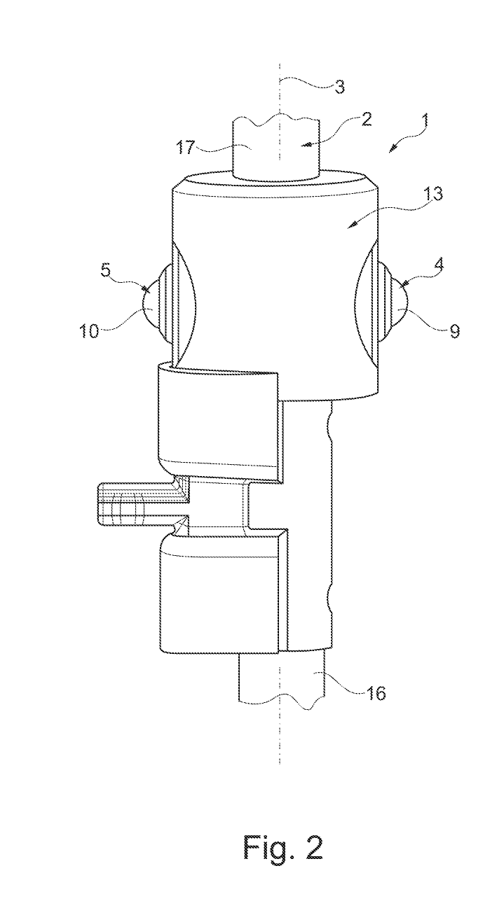

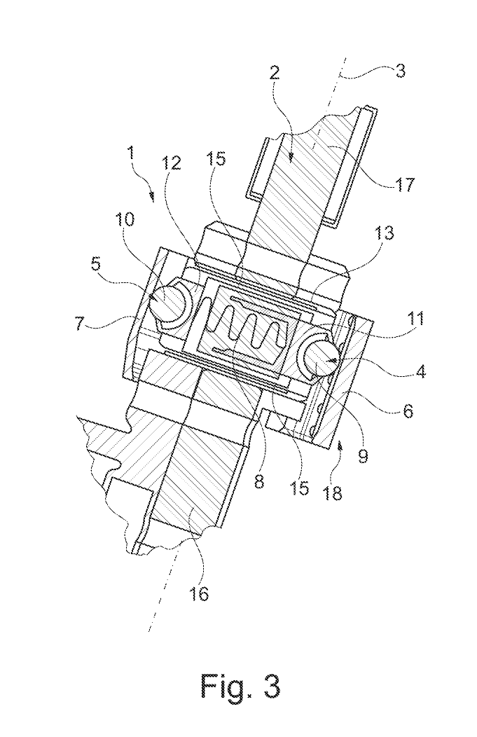

The housing 50 can be a plastic housing and serves for the mounting of an internal gear shift, which for example serves for shifting the manual transmission 100. In order to be able to utilize such a compact housing as the housing 50 of FIG. 1, a gear shift of a correspondingly compact construction is required. Such a gear shift is realized through an internal gear shift 1, as it is evident from FIGS. 2 and 3. FIG. 2 shows—in schematic representation—a part of the gear shift 1 in a lateral view. FIG. 3 shows in schematic representation the part of the gear shift 1 according to FIG. 2.

The gear shift 1 comprises a shifting shaft 2, which is for example mounted rotatably about its shaft axis 3 and displaceably in axial direction. Through the rotatability of the shifting shaft it is possible to actuate a shifting body, for example a shifting fork which is operationally connected to the shifting shaft 2 (not shown in the FIGS. 2 and 3), by engaging a gear. Through the axial displaceability of the shifting shaft 2 it is possible to move the shifting shaft 2 along a shifting gate in order to actively engage the shifting shaft 2 with another shifting body, thus engaging another gear.

In an embodiment, the gear shift 1 furthermore comprises at least two engagement elements 4 and 5, which are assigned to the shifting shaft 2 and radially project from the shifting shaft 2 towards the outside. In one embodiment, the engagement elements 4 and 5 are arranged diametrically located opposite one another.

As is evident in particular from FIG. 3, the engagement elements 4 and 5 interact with counter-engagement means 6 and 7 in order to lock the shifting shaft 2 in at least one rotary position and in at least one stroke position. For example, one of the engagement elements 4, 5 serves for locking the shifting shaft 2 in the stroke position and the other one of the engagement elements 4, 5 for locking the shifting shaft 2 in the rotary position.

The compact design of the gear shift 1 is caused among other things through a spring element 8 jointly utilized by the engagement elements 4 and 5, as is evident in particular from FIG. 3. The spring element 8 is arranged between the engagement elements 4 and 5 and serves in order to move, through its force, the engagement elements 4 and 5 each against the associated counter-engagement means 6 and 7 respectively, thereby locking the shifting shaft 2 in the respectively existing stroke position and/or rotary position.

In an embodiment, the engagement elements 4 and 5 can be moved towards the outside through the force of the common spring element 8 in radial direction with respect to the shifting shaft 2 and are held in the locking position on the associated counter-engagement means 6 and 7 respectively through the spring force. To this end, the engagement elements 4 and 5 are located on the inside and the counter-engagement means 6 and 7 opposite the engagement elements 4 and 5 are arranged located outside.

In another embodiment, the engagement elements 4 and 5 are arranged in a common plane which is substantially located perpendicularly to the axis 3 of the shifting shaft 2. Here, the engagement elements 4 and 5 are moveably mounted in radial direction with respect to the shifting shaft 2 in such a manner that the engagement elements 4 and 5 move in the plane or move in a common plane substantially located perpendicularly to the axis 3 of the shifting shaft 2.

As is evident, in particular, from FIG. 3, the engagement elements 4 and 5 are each formed through an engagement body 9 and 10 respectively and a support body 11 and 12 respectively connected therewith in a fixed manner, wherein the engagement body 9 and 10 respectively can be formed for example in the manner of a sphere. The support body 11 and 12 respectively is for example embodied in an oblong manner and on its one end comprises the engagement body 9 and 10 respectively.

As is evident, in particular, from FIG. 3, the support bodies 11, 12 can be formed as hollow cylinder, wherein the one support body 11 is at least partially pushed into the other support body 12 and because of this mounted relative to the support body 12. Here, the spring element 8 can be received within the hollow space of the support body 11 located inside.

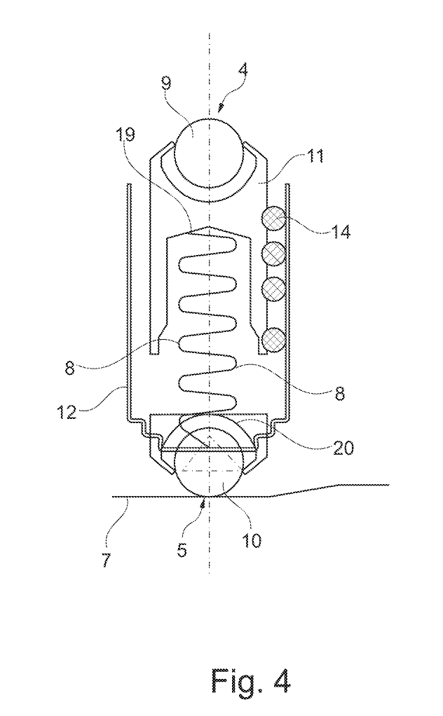

As is evident from FIG. 4, the spring element 8 can support itself on the one hand against a bottom surface 19 of the support body 11 located inside and on the other hand against for example a bottom surface 20 of the support body 12 located outside. Because of this, a spring force substantially acting in longitudinal direction of the support bodies 11 and 12 is generated when the spring element 8 is tensioned.

As is exemplarily shown in FIG. 4, the inner support body 11 can be mounted on the support body 12 located outside through a bearing in the manner of a rolling bearing 14 acting in radial direction which is connected in between.

Furthermore, the support body 12 located outside is for example moveably mounted with respect to a housing 13 or a mounting for the engagement elements 4 and 5, wherein between the support body 12 and the housing 13 a bearing 15 acting in radial direction with respect to the cylindrically formed support body 12 in the manner of a rolling bearing or sliding bearing can be connected in between (FIG. 3).

As is evident, in particular, from FIG. 3, in an embodiment, the shifting shaft 2 is divided in two through at least two longitudinal portions 16 and 17. One end each of the respective longitudinal portion 16 and 17 respectively is connected to the housing 13 for the engagement elements 4 and 5 in a fixed manner, so that the shifting shaft 2 despite intermediate connection of the engagement elements 4 and 5 can carry out the stroke movement as well as its rotary movement.

The counter-engagement means 6 and 7 can be formed on the inner circumference of a hollow cylinder 18. To this end, the inner circumference of the hollow cylinder 18 can comprise a contour which is formed in a suitable manner, so that in at least one or a plurality of stroke positions of the shifting shaft 2 the engagement element 4 can engage in an associated mounting of the contour each, thus establishing the locking. Likewise, a corresponding contour can be formed over a portion of the inner circumference so that in at least one or a plurality of rotary positions, in particular angles of rotation of the shifting shaft 2, the engagement element 5 gets into an engagement position in an associated mounting of this contour and locking with respect to the rotary movement of the shifting shaft 2 is thus achieved.

In an embodiment, the counter-engagement means 6 and 7, in particular the hollow cylinder 18, are preferably arranged in a housing-fixed manner with respect to a gear shift housing, in particular the housing 50 and/or the transmission housing 110, as is evident from FIG. 1.

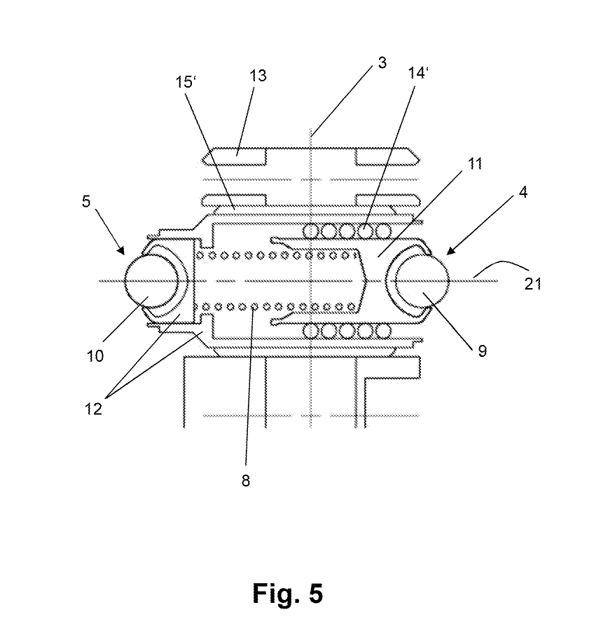

FIG. 5 shows a mounting example for the engagement elements 4 and 5 of the gear shift 1 according to the FIGS. 2 to 4. Components of the representation according to FIG. 5, which are identically or functionally identical to the components of the gear shift 1 according to the FIGS. 2 to 4, are provided with the same reference characters; in this respect, reference is made to the description regarding the gear shift 1 according to the FIGS. 2 to 4.

In FIG. 5, the counter-engagement means have been omitted for the sake of simplicity. The shifting shaft has been likewise omitted for the sake of simplicity and instead merely the shaft axis 3 shown.

As is evident from FIG. 5, in an exemplary embodiment, the support body 11 is translatorically displaceably mounted in the support body 12 of the engagement element 5 formed as a hollow shaft. To this end, the support body 11 supports itself with its outer circumference against a bearing 14′, which in turn supports itself against the inner circumference of the support body 12, into which the bearing 14′ together with the support body 11 is pushed. The bearing 14′ is formed as an axial bearing in order to be able to at least minimally translatorically displace the support body 11 relative to the support body 12 against the force of the spring element 8 and thus bring the engagement elements 4 and 5 into the aspired locking position against the respective counter-engagement means (not shown in FIG. 5). With the embodiment according to FIG. 5, the bearing 14′ is formed as a recirculating ball bushing although it will be appreciated that the bearing 14′ can also be formed in another way.

The support body 12 located outside supports itself with its outer circumference against a bearing 15′, which in turn supports itself against the housing 13 and the mounting, which is connected to the shifting shaft (not shown in FIG. 5) in a rotationally fixed and displacement-fixed manner. In the embodiment according to FIG. 5, the bearing 15′ is formed as sliding bushing, which is inserted into a through-opening of the housing 13, wherein the support body 12 is pushed into the interior of the housing. The bearing 15′ is configured in such a manner that the support body 12 can be at least slightly moved translatorically in the direction of the axis 21 to and fro with respect to the housing 13.

The bearing 15′ can be arranged on the support body 12 in a rotationally fixed and/or displacement-fixed manner, so that the bearing 15′ can be moved relative to the housing 13. It can also be that the bearing 15′ is arranged on the housing 13 in a rotationally fixed and/or displacement-fixed manner so that the support body 12 can be moved relative to the bearing 15′. Finally, it is also conceivable that the bearing 15′ can be moved relative to the support body 12 and relative to the housing 13, in particular can be rotationally moved and/or displaced.

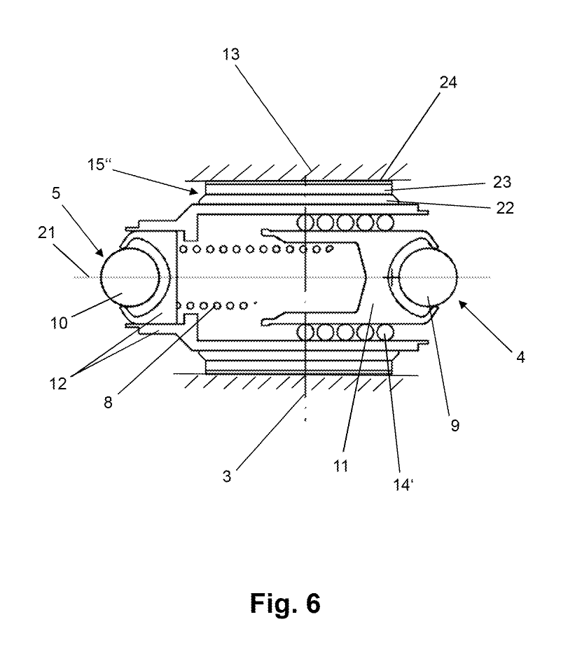

FIG. 6 shows a detail from a gear shift, which for example can be the gear shift of the FIGS. 2 and 3. From FIG. 6 a portion of the support body 11 and of the support body 12 is evident, which are mounted against one another through the rolling bearing 14′. From FIG. 6, a part of the housing 13 is also evident, on which the support body 12 is mounted. In an exemplary embodiment, between the support body 12 and the housing 13, a bearing 15″ is provided, which is formed for example as a sliding bearing, in particular a bearing bushing.

The ball of the sliding bearing 15″ is constructed in multiple layers and comprises a plastic layer 22 located inside and a metal structure 24 surrounding the plastic layer 22 in particular located outside. Between the metal structure 24 and the plastic layer 22, an elastomer structure 23 can be additionally present. The metal structure 24 can be formed in the manner of a metal sleeve.

In another embodiment, the support body 12 is likewise formed of plastic at least in the contact region with the plastic layer 22 of the bearing 15″, so that because of this an optimum sliding pairing is established. The bearing 15″ furthermore is press-fitted against the housing 13 by means of the metal structure 24, wherein the housing 13 is likewise formed of metal at least in the contact region with the metal structure 24.

Through the engagement elements 4 and 5, which according to an embodiment are moved against the force of the one common spring element 8, a double-acting detent which acts in radial direction with respect to the axis 3 towards the outside or can be moved towards the outside is realized. This double-acting detent is formed in a unit and therefore constructionally configured substantially more compact than for example separate detents that have been used up to now for locking the shifting shaft 2 in stroke direction and in swivel direction.

The gear shift cover can be guided in a more compact manner, which facilitates the mounting of the gear shift cover to the housing of the manual transmission in the case of compact motor vehicles. The production costs of the manual transmission are also substantially reduced through the invention.

Through the engagement elements, any friction forces on the bearing points of the engagement elements can be kept low. A simple mounting of the gear shift as contemplated herein, in particular of the engagement elements provided thereon, is also possible. Any elaborate and cost-intensive press fits for the engagement elements are not required.

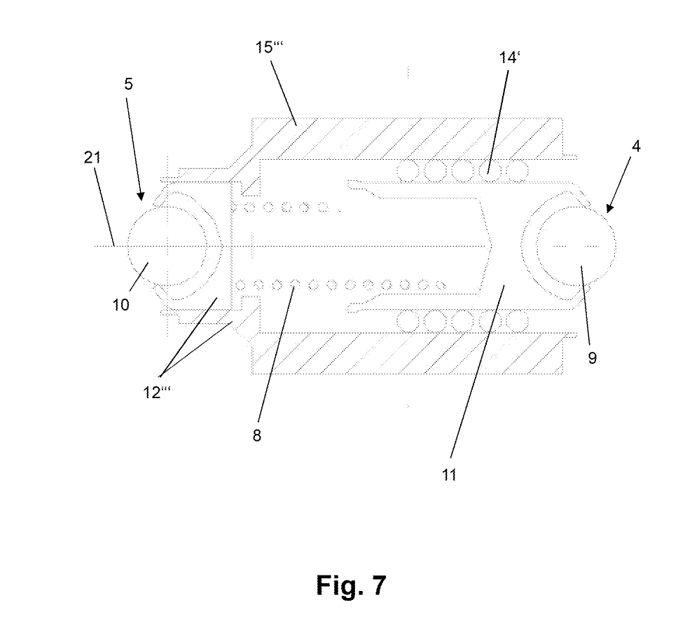

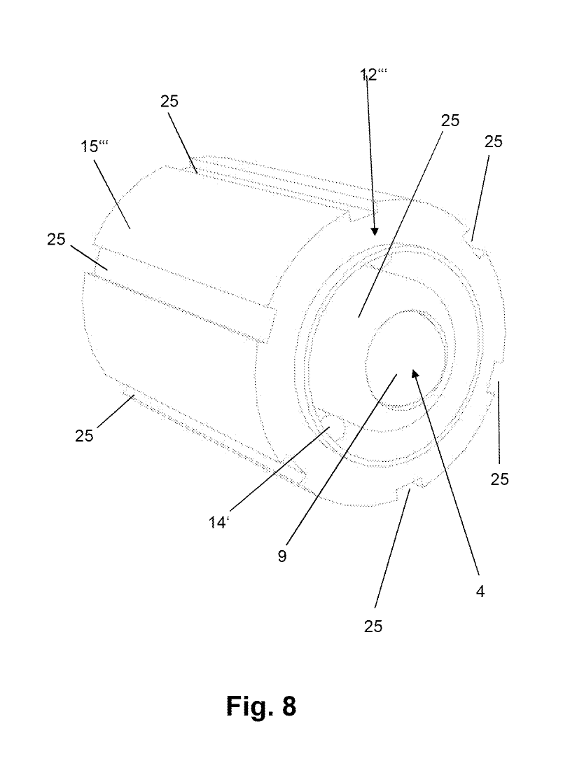

FIGS. 7 and 8 show a further possible mounting embodiment for the mounting of the engagement elements, as it is employed in the gear shift according to the FIGS. 2 and 3, in two different representations.

There, a support body 12″′ is provided, on which a bearing 15″′ for example in the manner of a sliding bearing or a bearing bushing is molded. The support body 12″′ and the bearing 15″′ preferably form a common plastic part or plastic hybrid part. The bearing 15″′ is in active contact with the shifting shaft 2 or the housing 13 according to FIGS. 2 and 3, which for the sake of simplicity is not shown in the FIGS. 7 and 8.

As is evident from FIG. 8, lubricant channels 25 can be provided on the outer circumference of the support body 12″′, on which the bearing 15″′ is formed. The lubricant channels are preferably arranged distributed over the circumference of the support body 12″′ and the bearing 15″′ at equidistant intervals with respect to one another and extend in axial direction, for example continuously in axial direction. The lubricant channels 25 are formed for example through material recesses on the outer circumferential surface of the support body 12″′ and of the bearing 15″′, for example in the manner of a longitudinal groove.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. An internal gear shift for a manual transmission, the internal gear shaft comprising:
a shifting shaft mounted rotationally moveably about its axis and displaceably in axial direction,
counter-engagement means; and
at least two engagement elements, which interact with the counter-engagement means in order to lock the shifting shaft in at least one rotary position and in at least one stroke position,
wherein one of the at least two engagement elements locks the shifting shaft in the at least one stroke position and the other one of the at least two engagement elements locks the shifting shaft in the at least one rotary position, and wherein the at least two engagement elements are movable against the counter-engagement means through the force of a common spring element.

2. The internal gear shift according to claim 1, wherein the at least two engagement elements are movable against the counter-engagement means in a radial direction with respect to the shifting shaft and the spring element is arranged between the at least two engagement elements.

3. The internal gear shift according to claim 1, wherein in a radial direction with respect to the shifting shaft the at least two engagement elements are arranged located inside and the counter-engagement means are located outside.

4. The internal gear shift according to claim 1, wherein the at least two engagement elements are arranged in a common plane located substantially perpendicularly to the axis of the shifting shaft.

5. The internal gear shift according to claim 1, wherein the at least two engagement elements are moveably mounted in a radial direction with respect to the shifting shaft, so that the at least two engagement elements move in a common plane which is located substantially perpendicularly to the axis of the shifting shaft.

6. The internal gear shift according to claim 1, wherein one of the at least two engagement elements is translatorically moveably mounted on the other of the at least two engagement elements, which in turn is translatorically moveably mounted on the shifting shaft.

7. The internal gear shift according to claim 6, wherein the one of the at least two engagement elements that is translatorically moveably mounted on the other of the at least two engagement element locks the shifting shaft in the at least one-rotary position.

8. The internal gear shift according to claim 1, wherein the at least two engagement elements each comprise an engagement body and a support body carrying the engagement body.

9. The internal gear shift according to claim 8, wherein the spring element supports itself against a first support body and against a second support body.

10. The internal gear shift according to claim 9, wherein the first support body is moveably mounted on the second support body in radial direction with respect to the shifting shaft, the second support body which in turn is moveably mounted on the shifting shaft in radial direction.

11. The internal gear shift according to claim 9, wherein the first support body is moveably mounted on the second support body in radial direction with respect to the shifting shaft subject to the intermediate connection of a first bearing, the second support body which in turn is moveably mounted on the shifting shaft in radial direction with respect to the shifting shaft subject to the intermediate connection of a second bearing.

12. The internal gear shift according to claim 11, wherein the second support body mounted on the shifting shaft and the second bearing assigned to the support body are a plastic part or plastic hybrid part.

13. The internal gear shift according to claim 11, wherein the second bearing arranged between the shifting shaft and the second support body is a sliding bearing in the manner of a bearing bushing with a wall comprising a plastic layer located inside surrounded by a metal structure.

14. The internal gear shift according claim 9, wherein the first and the second support bodies are formed as hollow cylinders with the first support body in the second support body, wherein the spring element is received inside the support bodies.

15. A manual transmission for a motor vehicle having an internal gear shift, the internal gear shaft comprising:
a shifting shaft mounted rotationally moveably about its axis and displaceably in axial direction,
counter-engagement means; and
at least two engagement elements, which interact with the counter-engagement means in order to lock the shifting shaft in at least one rotary position and in at least one stroke position,
wherein one of the at least two engagement elements locks the shifting shaft in the at least one stroke position and the other one of the at least two engagement elements locks the shifting shaft in the at least one rotary position, and wherein the at least two engagement elements are movable against the counter-engagement means through the force of a common spring element.

16. The internal gear shift according to claim 6, wherein one of the at least two engagement elements is translatorically moveably mounted on the other of the at least two engagement elements, which in turn is translatorically moveably mounted in a mounting or a housing of the shifting shaft.

17. The internal gear shift according to claim 12, wherein the second bearing is molded to the second support body.

18. The internal gear shift according to claim 13, wherein the second bearing arranged between the shifting shaft and the second support body is a sliding bearing in the manner of a bearing bushing with a wall comprising a plastic layer located inside surrounded by a metal structure and an elastomer structure.
